(19) United States
(12) Patent Application Publication
(10) Pub. No.: US 2007/0236360 A1
(43) Pub. Date: Oct. 11, 2007

(54) System and method for illuminating a transmitter

(75) Inventor: James J. Fitzgibbon, Batavia, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc.

(21) Appl. No.: 11/393,424

(22) Filed: Mar. 30, 2006

(51) Int. Cl. G08B 21/00; B60R 25/00; G08B 13/00; G08C 19/00

(52) U.S. Cl. 340/686.6; 340/541; 340/825.72; 340/5.7

(57) ABSTRACT

A user is provided with a transmitter, for example, an activated barrier movement operator code transmitter. The transmitter includes an indicator such as an illumination device. A proximity sensor senses the proximity of a portion of a user (e.g., the hand of the user) to the transmitter. Subsequently, the indicator (e.g., the illumination device) is actuated to illuminate a portion of the code transmitter to facilitate the visibility of at least one transmitter function to the user.

### FIELD OF THE INVENTION

The field of the invention relates to moveable barrier operators and, more specifically, to activating transmitters in these systems.

### BACKGROUND

Different types of moveable barrier operators have been sold over the years and these systems have been used to actuate various types of moveable barriers. For example, garage door operators have been used to move garage doors and gate operators have been used to open and close gates.

Such barrier movement operators may include a wall control unit, which is connected to send signals to a head unit thereby causing the head unit to open and close the barrier. In addition, these operators often include a receiver unit at the head unit to receive wireless transmissions from a hand-held code transmitter or from a keypad transmitter, which may be affixed to the outside of the area closed by the barrier or other structure.

Transmitters are used under many different types of environmental conditions. For example, the transmitters may need to be operated when it is dark and it is difficult for a user to see the transmitter. In another example, wet, foggy, or snowy conditions may make it difficult for a user to see the transmitter. Under these adverse conditions, it may be difficult or impossible for the user to activate the transmitter. This may prove to be undesirable or even dangerous in many situations where a quick entry into the area controlled by the barrier entry system is desired or required.

In previous systems, lights at the device may be activated when a button on the device is touched. Unfortunately, it may be difficult or impossible in many situations to initially locate the device or the button. Consequently, the user is still faced with the problem of not finding or activating the device in order to quicky actuate the barrier.

### SUMMARY

A system and method are provided that actuate an illumination device so that a user can easily see a transmitter. Specifically, proximity of a portion of a user (e.g., the hands of the user) causes an illumination device to activate and illuminate the transmitter. Consequently, under difficult environmental conditions where it is otherwise difficult or impossible to see the transmitter, the user can easily see the transmitter and/or a user interface on the transmitter in order to actuate functions of the transmitter.

In accordance with the principles described herein, a user is provided with a transmitter, for example, an activated barrier movement operator code transmitter. The transmitter includes an indicator such as an illumination device. A proximity sensor senses the proximity of a portion of a user (e.g., the hand of the user) to the transmitter. Subsequently, the indicator (e.g., the illumination device) is actuated to illuminate a portion of the transmitter to facilitate the visibility of transmitter functions to the user.

Subsequent to activating the illumination device, the transmitter may be actuated to send a code. The transmitter may learn the code to send upon sensing the proximity of the portion of the user. The indicator (e.g., illumination device) may be activated at a first distance between the portion of the user and the transmitter and the transmitter may be activated at a second distance between the portion of the user and the transmitter. In one example, the first distance is greater than the second distance.

In other approaches, multiple indicators and/or multiple sensors may be used. For instance, the sensors may be used to determine the indicator that is closest to the user and the closest indicator to the user may be illuminated.

In other examples, an activation location associated with the portion of the user may be determined. The transmitter code may be determined and based upon the activation location.

Various types of sensing arrangements and approaches may also be used to determine user proximity. For example, a capacitance may be sensed. In another approach, radio frequency (RF) energy may be detected. In another example, infrared energy may be detected. In still another approach, visible light may be sensed.

Thus, approaches are provided where a transmitter or a portion of a transmitter is illuminated when the proximity of a user or a portion of a user is detected. In so doing, transmitter functions are visible to the user even when environmental conditions are dark, wet, or otherwise less than optimal. Therefore, the user can quickly actuate a barrier operator even under difficult operating conditions.

### BRIEF DESCRIPTION OF THE DRAWINGS

FIG. 1 is one example of a system that actuates an illumination device on a transmitter according to the present invention;

FIG. 2 is a diagram of a transmitter according to the present invention;

FIG. 3 is a flowchart of an approach for activating an indicator on a transmitter according to the present invention;

FIG. 4 is a flowchart of another approach for activating an indicator on a transmitter according to the present invention;

FIG. 5 is a diagram of one example of an illumination device as used in a transmitter according to the present invention;

FIG. 6 is a diagram of a transmitter in a system where zones are determined according to the present invention;

FIG. 7 is a flowchart of the operation of the transmitter shown in FIG. 6 according to the present invention; and

FIG. 8 is a diagram of a transmitter having multiple sensors according to the present invention.

Skilled artisans will appreciate that elements in the figures are illustrated for ease of understanding and have not necessarily been drawn to scale. For example, the dimensions of some of the elements in the figures may be exaggerated relative to other elements to help to improve understanding of various embodiments of the present invention. Also, common but well-understood elements that are useful in a commercially feasible embodiment are often not depicted in order to facilitate a less obstructed view of the various embodiments of the present invention.

### DESCRIPTION

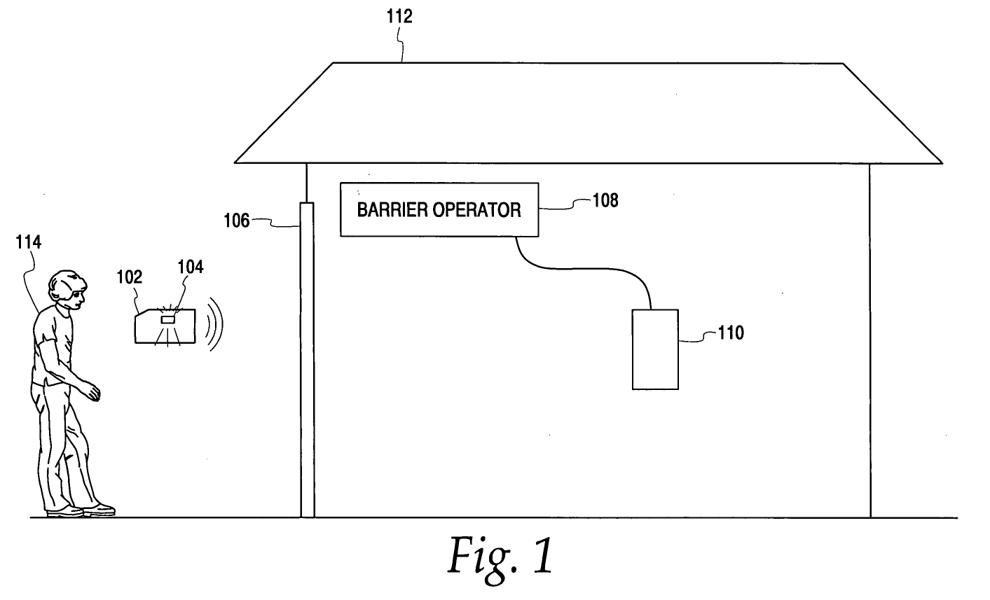

Referring now to the drawings and especially FIG. 1, one example of a system for illuminating portions of a transmitter is described. Many of the examples described herein relate to a transmitter that is used in a moveable barrier operator system. However, the approaches described herein are applicable to all types of transmitters that are used to actuate all types of remote devices such as televisions, stereos, or automobiles.

A transmitter 102 is used by a user 114 to actuate a barrier operator 108 in a moveable barrier operator system. The operator 108 moves a barrier 106. In addition, a wall control unit 110 may also allow the user 114 to open and close the barrier 106, program the operator 108 or perform other functions. The operator 108 is housed in a garage 112. The transmitter 102 includes an indicator 104 that is used to illuminate the transmitter 102 when the transmitter 102 senses the proximity of the user 114.

The transmitter 102 may include one or more functions to actuate the barrier operator 108 and may be positioned in various locations to aid in actuating the barrier operator 108. For example, the transmitter 102 may be carried in a vehicle of the user 114. In another approach, the transmitter 102 may be attached to the garage 112. Other locations can also be used to position the transmitter 102. The transmitter may send codes that actuate various barrier functions such as opening the barrier, closing the barrier, actuating a light, or actuating a security system. The transmitter 102 may also have a learn mode where it learns the various codes.

The system of FIG. 1 is depicted as having a barrier operator 108 that is a garage door operator and a barrier 106 that is a garage door. However, it will be understood that many different types of barrier operators and barriers may be used. For example, the barrier operator 108 may be a gate operator and a sliding door operator. In another example, the barrier 106 may be a front door, sliding gate, swinging gate, or shutters. Other examples of barriers and barrier operators are possible.

In one example of the operation of the system of FIG. 1, a proximity sensor or sensors at the transmitter 102 senses the proximity of a portion of a user to the transmitter 102. For example, the presence of a users hand may be detected. In another example, the presence of the arm of the user is detected. The detection of the presence of the user or a portion of the user may be accomplished by any suitable sensing arrangement such as a capacitive sensor, passive or active infrared sensor, light sensor, RF sensor, or a sonic sensor. Other sensors may also be used.

Subsequent to the detection of the presence of the user 114, the indicator 104 (e.g., the illumination device) is actuated to illuminate a portion of the code transmitter 102. The illumination facilitates the visibility of at least one transmitter function to the user. For example, light emitting diodes may be embedded at the transmitter and control buttons on the transmitter may be illuminated. Consequently, if the user 114 is in a dark location or otherwise undesirable environmental conditions exist that interfere with their viewing of the transmitter 102, the transmitter 102 becomes illuminated making it easy for the user 114 to utilize the functions of the transmitter 102.

Subsequent to activating the illumination device, the transmitter 102 may be actuated to send a code to actuate the operator 108. The transmitter 102 may learn the code to send upon sensing the proximity of the portion of the user 114.

In another example, the indicator 104 (e.g., illumination device) may be activated at a first distance between the portion of the user and the transmitter. The transmitter 102 may be activated to send a code when it resides at a second distance between the user 114 and the transmitter 102. In this case, the first distance is greater than the second distance.

In other examples, an activation location associated with the portion of the user 114 may be determined. The transmitter code may be determined and based upon the activation location. In this regard, different codes may be sent depending upon where the presence of the user 114 was detected. For example, different codes may be sent depending upon whether the user 114 was detected directly in front of, to the right, or to the left of the transmitter 102.

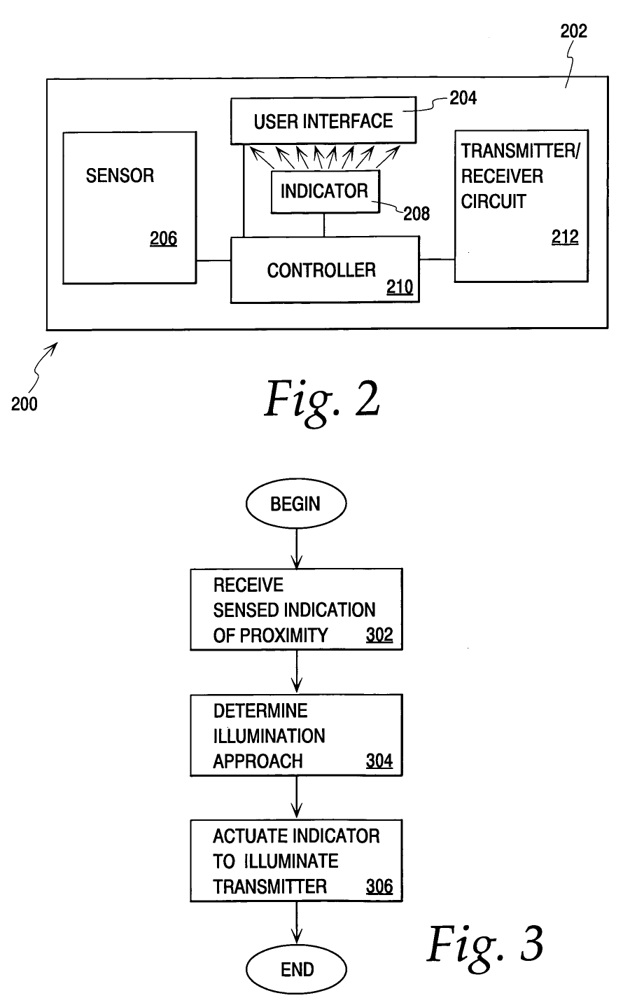

Referring now to FIG. 2, one example of a transmitter 200 is described. The transmitter 200 includes a controller 210. The controller 210 is coupled to a user interface 204, indicator 208, sensor 206, and transmitter/receiver circuit 212.

The sensor 206 senses the proximity of a portion of a user to the transmitter 200. In this regard, the sensor 206 may be a capacitance sensor, a radio frequency (RF) energy detector, a passive or active infrared energy sensor, or a visible light sensor. Other examples of sensors are possible. In addition, more than one sensor may be used.

In one specific example, and as mentioned, the sensor 206 may be a capacitance sensor. In this case, the sensor may detect changes in capacitance as objects come into proximity of the sensor 206. The change in capacitance may be compared to the threshold and when the change exceeds the threshold, it may be determined that an object is in proximity to the sensor 206.

The user interface 204 accepts commands from the user. In this regard, the user interface may comprise one or more buttons, a keypad, a touch screen, or any other device allowing the user to enter input data into the system.

One or more indicators 208 are positioned to illuminate at least a portion of the user interface. For example, the indicators may be illumination devices such as light emitting diodes.

The transmitter/receiver circuit 212 transmits a signal to an external device (e.g., barrier operator, television, stereo or computer) in order to actuate the external device. The transmitter/receiver circuit 212 may transmit a code to the operator and the code may be learned by the transmitter/receiver circuit 212.

The controller 210 is programmed to receive an indication of the proximity of the portion of the user from the sensor 206 and responsively activate the indicator 208 in order to illuminate the at least a portion of the user interface 204. For example, an LED may be activated to illuminate a transmit button on the user interface 204.

In other examples, the controller 210 is programmed to, subsequent to actuating the at least one illumination device, actuate the transmitter 200 to transmit a code. The controller 210 may also be programmed to learn the code upon sensing the proximity of the user.

In other examples, the controller 210 is programmed to activate the indicator 208 at a first distance between the portion of the user and transmitter. Additionally, the controller 210 is programmed to activate the transmitter 200 at a second distance between the portion of the user and transmitter. In this example, the first distance is greater than the second distance.

In other examples, the controller 210 is programmed to determine an activation location associated with the portion of the user. A code may also be determined based upon the activation location.

In still other examples, multiple sensors may be used to detect multiple proximities and activate selected illumination devices. In this case, the illumination device closest to the portion of the user may be illuminated.

Referring now to FIG. 3, one example of operating a transmitter is described. At step 302, an indication of the proximity of a user is received. This may be in the form of a signal from a sensor such as a capacitance sensor or an infrared sensor. At step 304, an approach is determined to illuminate at least a portion of the user interface. For example, a LED may be activated automatically. In other example, the LED may be activated, but with varying intensities based upon factors such as the distance of the user. In other examples, selected portions of the interface may be illuminated based upon factors such as the time of day, user distance, or user location. At step 306, the indicator or indicators are actuated to illuminate the selected portion of the user interface as previously determined.

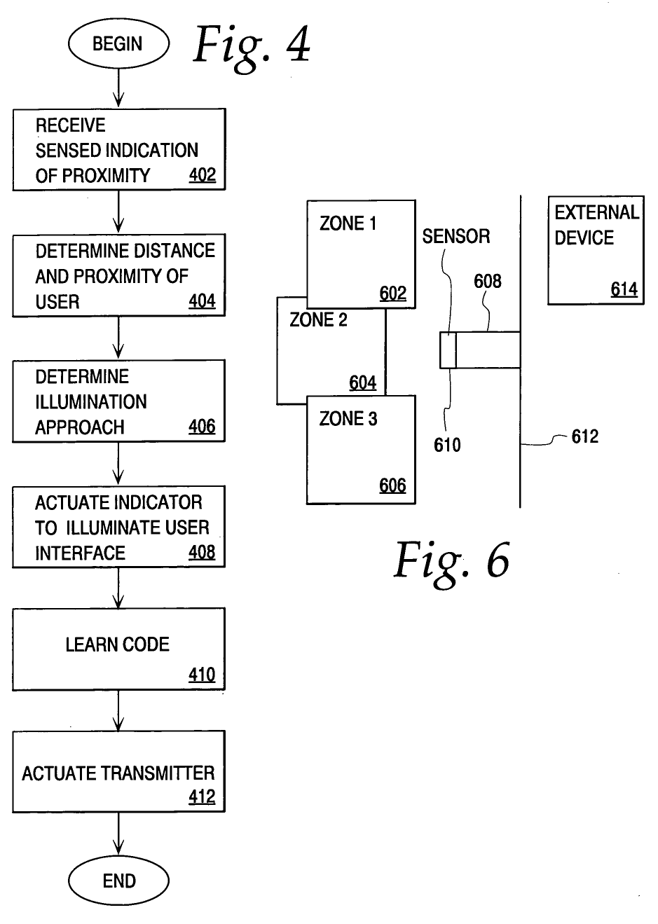

Referring now to FIG. 4, another example of operating a transmitter is described. At step 402, an indication of the proximity of a user is received. This may be in the form of a signal from a sensor such as a capacitance sensor or an infrared sensor. At step 404, the signal is processed to determine whether the user is located proximately to the transmitter and to determine a distance to the user.

At step 406, an approach is determined to illuminate at least a portion of the user interface. For example, a LED may be activated automatically. In other example, the LED may be activated but with varying intensities based upon factors such as the distance of the user. In other examples, certain portions of the interface may be illuminated based upon factors such as the time of day, user distance, or user location. At step 408, the indicator or indicators are actuated to illuminate the selected portions of the user interface as previously determined.

At step 410, a code is learned by the transmitter. At step 410, the transmitter is actuated to send the code to actuate an external device (e.g., barrier operator, television, stereo or computer).

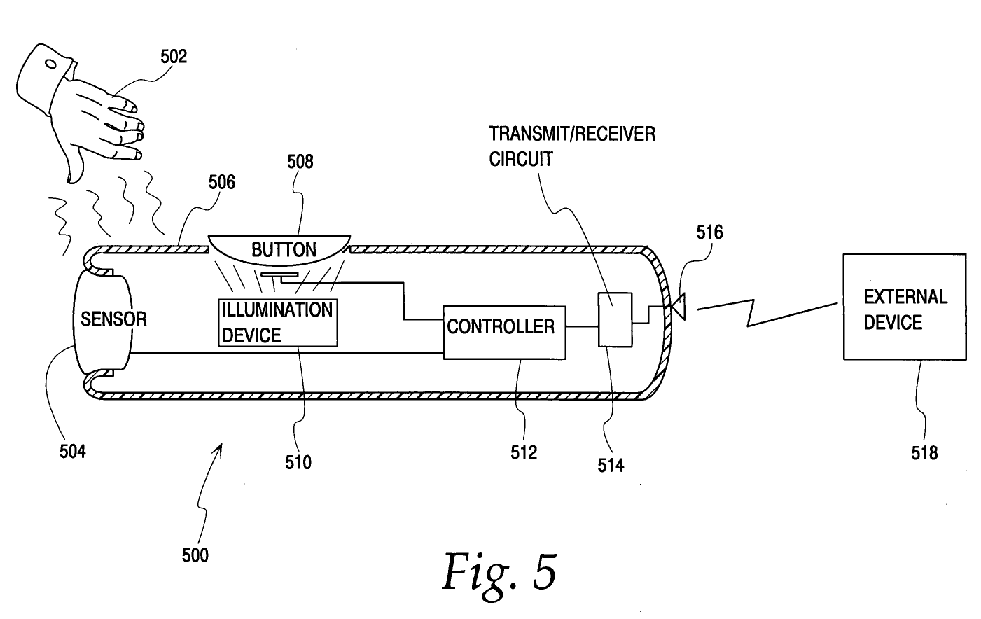

Referring now to FIG. 5, another example of a transmitter is described. A transmitter 500 includes a sensor 504, an illumination device 510, a controller 512, and a transmit/receive circuit 514 (with an antenna 516). A button 508 acts as a transmit button. When pressed, the button 508 causes the controller 512 to actuate the transmit/receive circuit 514 to send a code to an external device 518 (e.g., barrier operator, television, stereo or computer). As shown, these elements reside in a transmitter case 506.

The sensor 504 may be any type of sensing arrangement such as a capacitance sensor, infrared sensor, sonic, RF sensor, or visible light sensor. The sensor 504 detects the proximity of a portion of a user (such as a hand 502 of a user). In addition, multiple sensors may be used. When the presence of the user is detected, the sensor 504 creates an electrical signal that is received at the controller 512. The controller 512 activates the illumination device 510, which illuminates the button 508. The button 508 may be of a translucent material aiding in the illumination.

In addition, an illumination medium (not shown) may be used to assist in illuminating the button 508. For example, light from the illumination device 510 may be transmitted through a clear plastic, which itself becomes illuminated and aids in illuminating the button 508.

More than one illumination devices may be used. In addition, the illumination device may be positioned at other locations of the transmitter 500. In one approach, multiple illumination devices may be used to illuminate different portions of the transmitter.

Referring now to FIG. 6, one example of a system for sensing different locations of a portion of a user is described. A transmitter 608 having a sensor 610 is attached to an entity 612. The entity 612 may be a building, vehicle, or some other device or building. Zones 602, 604, and 606 are positioned about the transmitter 608. The transmitter 608 is programmed to illuminate a different part of its user interface depending upon the zone where the presence of the user is detected. In addition, the user may also send different codes to an external device 614 (e.g., barrier operator, television, stereo or computer) depending upon the zone where the presence of the user is detected.

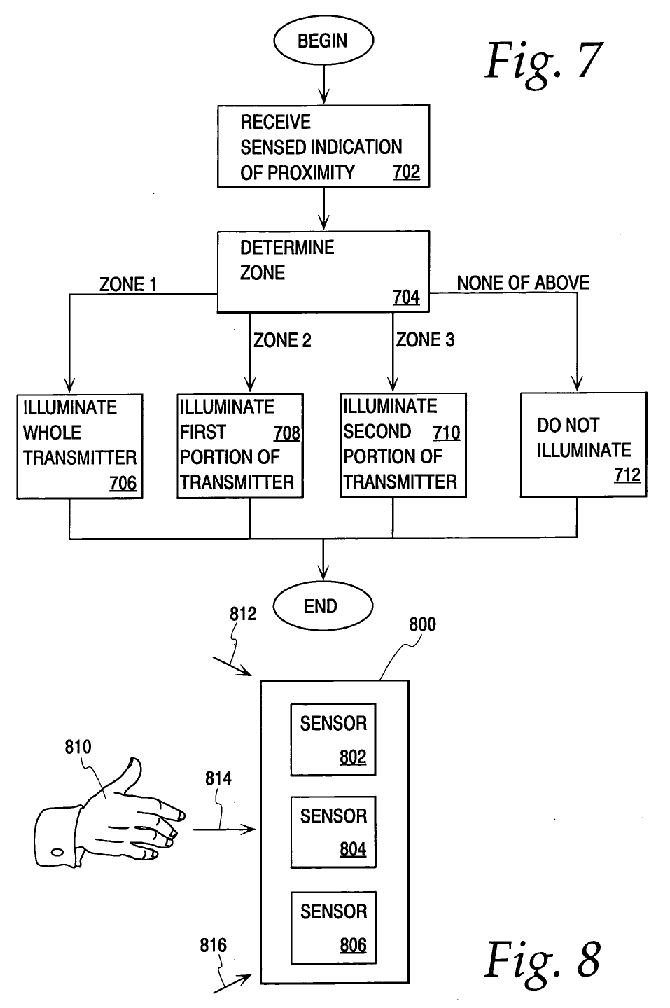

Referring now to FIG. 7, an example of operating the transmitter 608 of FIG. 6 is described. At step 702, an indication of the proximity of a user is received. This may be in the form of a signal from a sensor such as a capacitance sensor or an infrared sensor.

At step 704, it is determined the zone where the user is located. If the user is located in Zone 1, step 706 is performed where the whole transmitter is illuminated. If the user is located in Zone 2, step 708 is performed where a first portion of the transmitter are illuminated. If the user is located in Zone 3, step 710 is performed where a second portion of the transmitter is illuminated. If the user is not in any of the zones, at step 712 no action is taken. In addition, as mentioned above, a different code may be sent from the transmitter depending upon the zone where the presence of the user was detected.

Referring now to FIG. 8, another example of a transmitter that senses the proximity of a user is described. A transmitter 800 includes sensors 802, 804, and 806. The sensors 802, 804, and 806 are positioned such that they can detect the proximity (or approach) of a portion of a user from any direction (e.g., above, below, under, to the left, to the right, or from any other direction). Consequently, the sensors 802, 804, and 806 can be positioned at various locations at the transmitter 800 depending upon the layout and dimensions of the transmitter 800, the type of sensor, and the directions for which a proximity detection is required. In addition, although three sensors are shown in FIG. 8, it will be understood that any number of sensors can be used.

A hand 810 of a user may approach the transmitter 800 from directions 812, 814, and 816. In this example, the sensors are positioned such that the sensor 802 will detect the hand 810 if it approaches from direction 812. Furthermore, the sensor 804 will detect the hand if it approaches from direction 814. Finally, the sensor 816 will detect the proximity of the hand if it approaches from direction 816.

Thus, approaches are provided that allow for a transmitter or a portion of a transmitter to become illuminated when the proximity of a user is detected. In so doing, transmitter functions are visible to the user even when environmental conditions are dark, wet, or otherwise less than optimal. Advantageously, the user can quickly perform barrier operator actuation functions even in bad operating environments.

While there has been illustrated and described particular embodiments of the present invention, it will be appreciated that numerous changes and modifications will occur to those skilled in the art, and it is intended in the appended claims to cover all those changes and modifications which fall within the true scope of the present invention.

What is claimed is:

1. A method for operating a transmitter in a movable barrier operator system comprising:
providing a user activated barrier movement operator code transmitter comprising an illumination device;
sensing, by at least one proximity sensor, a proximity of a portion of a user to the code transmitter; and
actuating the illumination device to illuminate a portion of the code transmitter to facilitate the visibility of at least one transmitter function to the user.

2. The method of claim 1 wherein the sensing comprises sensing by more than one sensor a proximity a portion of a user.

3. The method of claim 1 comprising, subsequent to activating the illumination device, actuating the transmitter to send a code.

4. The method of claim 3 comprising teaching the transmitter the code to send upon sensing the proximity of the portion of the user.

5. The method of claim 3 wherein activating the illumination device occurs at a first distance between the portion of the user and the transmitter and activating the transmitter occurs at a second distance between the portion of the user and the transmitter and wherein the first distance is greater than the second distance.

6. The method of claim 1 wherein sensing the movement comprises determining an activation location associated with the portion of the user.

7. The method of claim 6 comprising determining a transmitter code based upon the activation location.

8. The method of claim 1 wherein sensing the proximity comprises sensing a capacitance.

9. The method of claim 1 wherein sensing the proximity comprises detecting radio frequency (RF) energy.

10. The method of claim 1 wherein sensing the proximity comprises sensing infrared energy.

11. The method of claim 1 wherein sensing the proximity comprises sensing visible light.

12. The method of claim 1 wherein sensing the proximity of the portion of the user comprises sensing a hand of the user.

13. A user activated barrier movement operator code transmitter for use in a moveable barrier system, comprising:
at least one sensor for sensing a proximity of a portion of a user;
a user interface for accepting commands from the user;
at least one illumination device positioned to illuminate at least a portion of the user interface; and
a controller coupled to the at least one sensor, the user interface, and the at least one illumination device, the controller programmed to receive an indication of the proximity of the portion of the user from the at least one sensor and responsively activate the at least one illumination device in order to illuminate the at least a portion of the user interface.

14. The transmitter of claim 13 wherein the at least one sensor comprises more than one sensor and the at least one illumination device comprises more than one illumination device.

15. The transmitter of claim 14 wherein the more than one illumination devices are illuminated according to the proximity.

16. The transmitter of claim 13 wherein the controller is programmed, subsequent to actuating the at least one illumination device, to actuate the transmitter to transmit a code.

17. The transmitter of claim 16 wherein the controller is programmed to learn the code upon sensing the proximity of the user.

18. The transmitter of claim 16 wherein the controller is programmed to activate the illumination device at a first distance between the portion of the user and transmitter and to activate the transmitter at a second distance between the portion of the user and transmitter, and wherein the first distance is greater than the second distance.

19. The transmitter of claim 13 wherein the controller is programmed to determine an activation location associated with the portion of the user.

20. The transmitter of claim 19 wherein the controller is programmed to determine a code based upon the activation location.

21. The transmitter of claim 13 wherein the at least one sensor comprises a capacitance sensor.

22. The transmitter of claim 13 wherein the at least one sensor comprises a radio frequency (RF) energy detector.

23. The transmitter of claim 13 wherein the at least one sensor comprises an infrared energy sensor.

24. The transmitter of claim 13 wherein the at least one sensor comprises a visible light sensor.

25. The transmitter of claim 13 wherein the user interface comprises at least one actuator that actuates functions of the moveable barrier system, the functions being selected from a group comprising: opening the barrier, closing the barrier, actuating a light, and actuating a security system.

26. A method for operating a transmitter in a movable barrier operator system comprising:
sensing a proximity of a portion of a user to a transmitter in a moveable barrier operator system; and
when the sensing indicates the proximity of the portion of the user, actuating at least one indicator at the transmitter, the actuating of the at least one indicator facilitating the visibility of at least one transmitter function to a user.

27. The method of claim 26 wherein actuating at least one indicator comprises actuating at least one illumination device.

28. The method of claim 26 comprising proving multiple sensors for the sensing and wherein the sensing comprises sensing multiple proximities and the actuating comprises actuating at least one indicator closest to the portion of the user.

29. The method of claim 26 comprising, subsequent to actuating the at least one indicator, actuating the transmitter.

30. The method of claim 29 comprising learning the code to send upon sensing the proximity of the portion of the user.

31. The method of claim 29 wherein activating the at least one indicator occurs at a first distance between the portion of the user and transmitter and activating the transmitter occurs at a second distance between the portion of the user and transmitter, and wherein the first distance is greater than the second distance.

32. The method of claim 26 wherein sensing the proximity comprises determining an activation location associated with the portion of the user.

33. The method of claim 32 comprising determining a transmitter code based upon the activation location.

34. The method of claim 33 wherein sensing the proximity comprises sensing a capacitance.

35. The method of claim 26 wherein sensing the proximity comprises detecting radio frequency (RF) energy.

36. The method of claim 26 wherein sensing the proximity comprises sensing infrared energy.

37. The method of claim 26 wherein sensing the proximity comprises sensing visible light.

38. A transmitter for use in a moveable barrier system comprising:
at least one sensor for sensing a proximity of a portion of a user;
a user interface for accepting commands from the user;
at least one indicator positioned at the user interface; and
a controller coupled to the at least one sensor, the user interface, and the at least one indicator, the controller programmed to receive an indication of the proximity of the portion of the user from the at least one sensor and responsively actuate the at least one indicator in order to facilitate visibility of the user interface for the user.

39. The transmitter of claim 38 wherein the at least one sensor comprises more than one sensor, the controller programmed to determine a closest user interface to the portion of the user from the indication of proximity received from the more than one sensors.

40. The transmitter of claim 38 wherein the at least one indicator is an illumination device.

41. The transmitter of claim 38 wherein the controller is programmed to, subsequent to actuating the at least one indicator, to actuate the transmitter to transmit a code.

42. The transmitter of claim 41 wherein the controller is programmed to learn the code upon sensing the proximity of the portion of the user.

43. The transmitter of claim 41 wherein the controller is programmed to activate the at least one indicator at a first distance between the portion of the user and transmitter and to activate the transmitter at a second distance between the portion of the user and transmitter, and wherein the first distance is greater than the second distance.

44. The transmitter of claim 38 wherein the controller is programmed to determine an activation location associated with the portion of the user.

45. The transmitter of claim 44 wherein the controller is programmed to determine a code based upon the activation location.

46. The transmitter of claim 38 wherein the at least one sensor comprises a capacitance sensor.

47. The transmitter of claim 38 wherein the at least one sensor comprises a radio frequency (RF) energy detector.

48. The transmitter of claim 38 wherein the at least one sensor comprises an infrared energy sensor.

49. The transmitter of claim 38 wherein the at least one sensor comprises a visible light sensor.

50. The transmitter of claim 38 wherein the user interface comprises at least one actuator that actuates functions of the moveable barrier system, the functions being selected from a group comprising: opening the barrier, closing the barrier, actuating a light, and actuating a security system.
